(19) United States
(12) Patent Application Publication
(10) Pub. No.: US 2010/0246441 A1
(43) Pub. Date: Sep. 30, 2010

(54) METHOD AND APPARATUS FOR MONITORING PACKET SERVICE

(76) Inventors: Dong Soo Jung, Daejeon (KR); Song In Choi, Daejeon (KR); Jee Hwan Ahn, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/743,950

(22) PCT Filed: Jun. 9, 2008
(86) PCT No.: PCT/KR08/03214

§ 371 Date: May 20, 2010

(30) Foreign Application Priority Data
Nov. 23, 2007 (KR) 10-2007-0120337

(51) Int. Cl. H04L 12/28

(52) U.S. Cl. 370/254

(57) ABSTRACT

The present invention provides a packet service electronic monitoring method in a wireless portable Internet system and an apparatus using the same. In the packet service electronic monitoring method, a packet service electronic monitoring start request is transmitted to a packet subscriber station (PSS) from a law enforcement agency and the packet service electronic monitoring is started. When the PSS attempts a packet service, electronic monitoring call information of the PSS is transmitted to the law enforcement agency, and an electronic monitoring subscriber packet of the PSS is transmitted to the law enforcement agency when the PSS is provided with the packet service.

### TECHNICAL FIELD

The present invention relates to a method for electronically monitoring a packet service and an apparatus using the same, and particularly, it relates to an electronic packet service monitoring method in a wireless portable Internet system, and an apparatus having the same.

The present invention is supported by the IT R&D program of MIC/IITA 112006-S-009-02, The Development of WiBro Service and Operating Standard).

### BACKGROUND ART

Currently, many countries in the world have made an effort to develop and efficiently manage a legitimate electronic monitoring function so as to efficiently deal with crime and terrorism. Particularly, introduction of various new communication systems and services causes the electronic monitoring function to be more complicated so that judicial and standardization organizations of each country constitute a standard electronic monitoring specification for each communication system for standard electronic monitoring and require a system that satisfies the specification.

In case of a packet service, electronic monitoring standards for the General Packet Radio Service (GPRS) in Europe and the Code Division Multiple Access (CDMA) 2000 system in the Northwest have been established and applied. However, an electronic monitoring standard for the portable Internet system has not been established yet.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a method for efficiently performing electronic monitoring of a packet service in a wireless portable Internet system, and an apparatus using the same.

### Technical Solution

In an exemplary packet service electronic monitoring method according to an embodiment of the present invention, a law enforcement agency requests to start an electronic monitoring of a packet service of a portable subscriber station (PSS) and starts the electronic monitoring of the packet service of the PSS, and electronic monitoring call information of the PSS is transmitted to the law enforcement agency when the PSS attempts a packet service. When the PSS is provided with a packet service, the packet of the PSS is transmitted to the law enforcement agency.

An exemplary packet service electronic monitoring apparatus according to another embodiment of the present invention includes a service provider-side electronic monitoring apparatusus and performs authentication and charging processes for a packet service when receiving the request from the service provider-side electronic monitoring apparatus.

### ADVANTAGEOUS EFFECTS

According to the present invention, a packet service can be electronically monitored while less influencing a packet service processing function than conventional monitoring.

### BRIEF DESCRIPTION OF THE DRAWINGS

FIG. 1 is a schematic diagram of a packet service electronic monitoring apparatus according to an exemplary embodiment of the present invention.

FIG. 2 is a flowchart of a packet service electronic monitoring method according to the exemplary embodiment of the present invention.

FIG. 3 shows an electronic monitoring start process of the packet service electronic monitoring apparatus according to the exemplary embodiment of the present invention.

FIG. 4 shows an electronic monitoring call information transmission process of the packet service electronic monitoring apparatus according to the exemplary embodiment of the present invention.

FIG. 5 shows an electronic monitoring subscriber station packet transmission process of the packet service electronic monitoring method according to the exemplary embodiment of the present invention.

FIG. 6 shows a packet service electronic monitoring cancel process of the packet service electronic monitoring method according to the exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise”, and variations such as “comprises” or “comprising”, will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

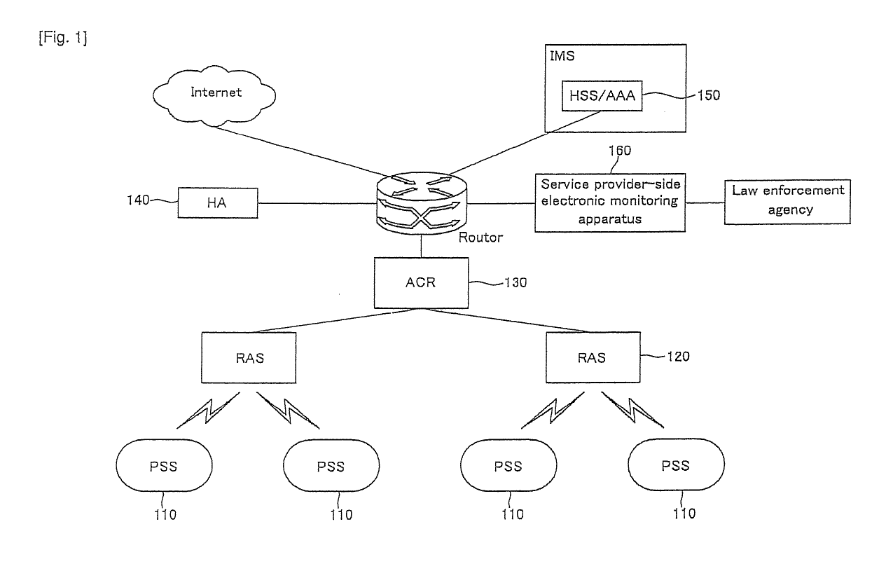

A packet service electronic monitoring apparatus according to an exemplary embodiment of the present invention will be described. FIG. 1 is a schematic diagram of a packet service electronic monitoring apparatus according to an exemplary embodiment of the present invention.

As shown in FIG. 1, a packet service electronic monitoring apparatus according to the exemplary embodiment of the present invention includes a portable subscriber station (PSS) 100, a radio access station (RAS) 120, an access control router (ACR) 130, a home agent (HA) 140, a home subscriber server/Authentication, Authorization, and Accounting (HSS/AAA) server 150, and a service provider-side electronic monitoring apparatus 160.

The ACR 130 is connected with the RAS 120, and collects electronic monitoring call information of a packet service and a subscriber packet when receiving a request to start packet service electronic monitoring for a specific subscriber from the service provider-side electronic monitoring apparatus 160, and transmits the collected information and subscriber packet to the service provider-side electronic monitoring apparatus 160.

The HA 140 performs a function for a mobile Internet protocol (IP).

As an integrated function of a HSS server that manages mobility of an IP multimedia subsystem (IMS)-based multimedia user and performs an authentication function and an AAA server that performs authentication and charging of the PSS 110, the HSS/AAA server 150 stores a location of a PSS, provides the stored location of the PSS upon a request from the service provider-side electronic monitoring apparatus 160, and performs authentication and charging processes for a packet service.

The service provider-side electronic monitoring apparatus 160 is connected with a law enforcement agency, and starts electronic monitoring when receiving a packet service electronic monitoring request for a PSS from the law enforcement agency and provides collected packet service electronic monitoring data. When receiving a packet service electronic monitoring cancel request from the law enforcement agency, the service provider-side electronic monitoring apparatus 160 cancels the electronic monitoring operation.

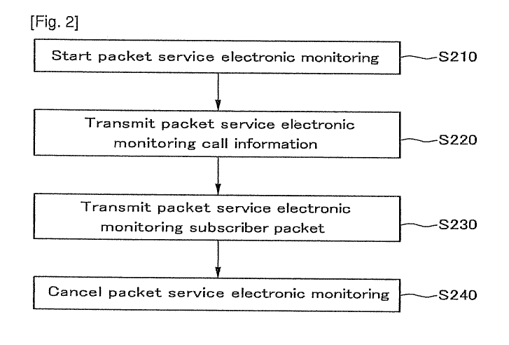

A packet service electronic monitoring method according to the exemplary embodiment of the present invention will now be described. FIG. 2 is a flowchart of the packet service electronic monitoring method according to the exemplary embodiment of the present invention.

As shown in FIG. 2, the packet service electronic monitoring apparatus receives a request from the law enforcement agency and starts a packet service electronic monitoring operation (S210).

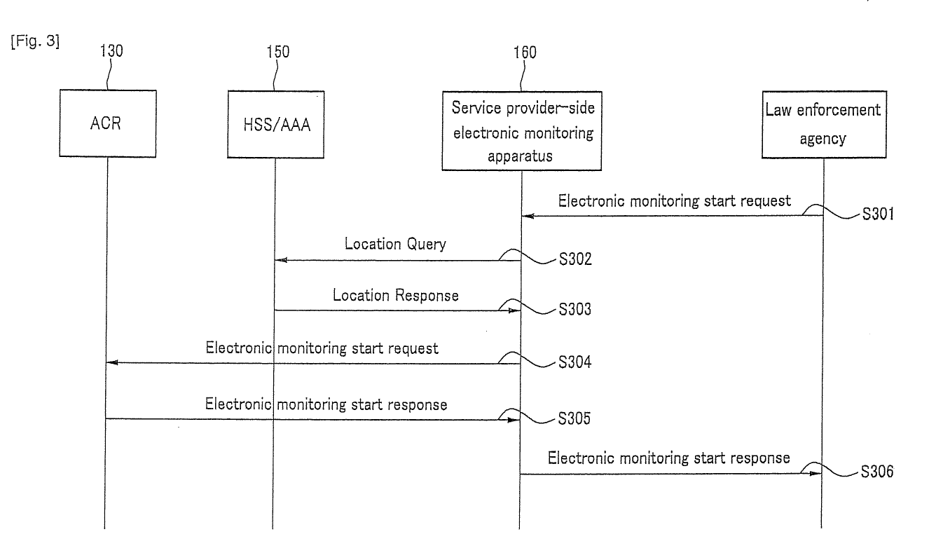

A packet service electronic monitoring start process will now be described with reference to FIG. 3. FIG. 3 shows an electronic monitoring start process of the packet service electronic monitoring method according to the exemplary embodiment of the present invention.

As shown in FIG. 3, the law enforcement agency requests to start packet service electronic monitoring for a PSS in the portable Internet system (S301), the service provider-side electronic monitoring apparatus 160 checks an electronic monitoring history of the requested subscribed station. If the checking result shows that the PSS is not in the monitoring state, the service provider-side electronic monitoring apparatus 160 requests a location of the PSS from the HSS/AAA server 150 (S302). When receiving a location response of the PSS (S303), the service provider-side electronic monitoring apparatus 160 requests the ACR 130 that manages calls of the PSS to start packet service electronic monitoring (S304).

After starting the packet service electronic monitoring for the PSS, the ACR 130 transmits an electronic monitoring start response to the service provider-side electronic monitoring apparatus 160 (S305). When receiving the electronic monitoring start response, the service provider-side electronic monitoring apparatus 160 stores information indicating that the PSS is under the packet service electronic monitoring, and transmits the electronic monitoring start response to the law enforcement agency (S306).

As shown in FIG. 2, when the PSS under electronic monitoring attempts a packet service, the packet service electronic monitoring apparatus transmits electronic monitoring call information of the PSS to the law enforcement agency (S220).

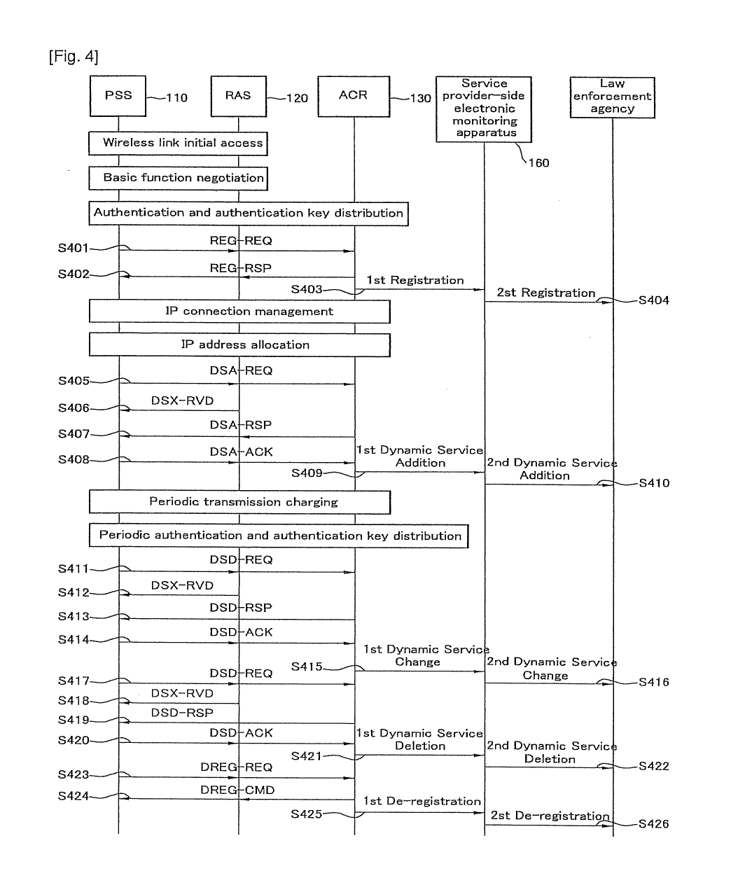

The electronic monitoring call information transmission process will now be described with reference to FIG. 4. FIG. 4 shows an electronic monitoring call information transmission flow of the packet service electronic monitoring method according to the exemplary embodiment of the present invention.

When the PSS 110 under the packet service electronic monitoring attempts a packet service, wireless link initial access, basic function negotiation, authentication, and authentication key distribution processes are performed between the PSS 110, the RAS 120, and the ACR 130.

When the PSS 110 transmits a registration request (REG_REQ) message to the ACR 130 through the RAS 120 (S401), the ACR 130 performs proper processes and transmits a registration response (REG_RSP) message to the PSS 110 through the RAS 120 (S402). In addition, when a subscriber station is under a packet service electronic monitoring start process, the ACR 130 transmits a first registration message to the service provider-side electronic monitoring apparatus 160 (S403). When receiving the first registration message, the service provider-side electronic monitoring apparatus 160 checks an electronic monitoring start history and transmits a second registration message to the law enforcement agency if the corresponding PSS is under the packet service electronic monitoring start process (S404).

In addition, IP connection management and IP address allocation processes are performed between the PSS 110, the RAS 120, and the ACR 130.

When the PSS 110 transmits a dynamic service addition request (DSA-REQ) message to the RAS 120 (S405), the RAS 120 transmits a dynamic service addition received (DSX-RVD) message to the PSS 110 in response to the DSA-REQ message (S406), and transmits the DSA-REQ message to the ACR 130. The ACR 130 performs proper processes and transmits a dynamic service addition response (DSA-RSP) message to the PSS 110 through the RAS 120 (S407). Then, the PSS 110 transmits a dynamic service addition acknowledge (DSA-ACK) message to the ACR 130 through the RAS 120 (S408).

The ACR 130 transmits a first dynamic service addition message to the service provider-side electronic monitoring apparatus 160 if the corresponding PSS is under the packet service electronic monitoring start process (S409). When receiving the first dynamic service addition message, the service provider-side electronic monitoring apparatus 160 checks the electronic monitoring start history and transmits a second dynamic service addition message to the law enforcement agency if the subscriber station is under the packet service electronic monitoring start process (S410).

Then, periodic transmission charging and periodic authentication and authentication key distribution processes are performed between the PSS 110, the RAS 120, and the ACR 130.

When the PSS 110 transmits a dynamic service change request (DSC-REQ) message to the RAS 120 in order to dynamically change an existing service flow (S411), the RAS 120 transmits a dynamic service change received (DSX-RVD) message to the PSS 110 in response to the DSC-REQ message (S412), and transmits the DSC-REQ message to the ACR 130. The ACR 130 performs proper processes and transmits a dynamic service change response (DSC-RSP) message to the PSS 110 through the RAS 120 (S413). When receiving the DSC-RSP message, the PSS 110 transmits a dynamic service change acknowledge (DSC-ACK) message to the ARC 130 through the RAS 120 (S414).

If the corresponding PSS is under the packet service electronic monitoring start process, the ACR 130 transmits a first dynamic service change message to the service provider-side electronic monitoring apparatus 160 (S415), and the service provider-side electronic monitoring apparatus 160 checks the packet service electronic monitoring start history when receiving the first dynamic service change message and transmits a second dynamic service change message to the law enforcement agency if the PSS is under the packet service electronic monitoring (S416).

When the PSS 110 transmits a dynamic service deletion request (DSD-REQ) to the

RAS 120 in order to delete the existing service flow (S417), the RAS 120 transmits a dynamic service deletion received (DSX-RVD) message to the PSS 110 in response to the DSD-REQ message (S418) and transmits the DSD-REQ message to the ACR 130. When receiving the DSD-REQ message, the ACR 130 performs proper processes and transmits a dynamic service deletion response (DSD-RSP) message to the PSS 110 through the RAS 120 (S419). Then, the PSS 110 transmits a dynamic service deletion acknowledge (DSD-ACK) message to the ACR 130 through the RAS 120 (S420).

The ACR 130 transmits a first dynamic service deletion message to the service provider-side electronic monitoring apparatus 160 if the corresponding PSS is under the electronic monitoring start process (S421), and the service provider-side electronic monitoring apparatus 160 checks the electronic monitoring start history when receiving the first dynamic service deletion message and transmits a second dynamic service deletion message to the law enforcement agency if the PSS is under the packet service electronic monitoring (S422).

In order to cancel a packet call after being provided with a packet service, the PSS 110 transmits a de-registration request (DREG-REQ) message that reports de-registration and cancellation of a normal operation service to the ACR 130 through the RAS 120 (S423). Then, the ACR 130 performs packet call release for the PSS 110 and transmits a de/re-register command (DREG-CMD) message to the PSS 110 through the RAS 120 (S424). If the PSS 110 is under the packet service electronic monitoring start process, the ACR 130 transmits the first de-registration message to the service provider-side electronic monitoring apparatus 160 (S425), and the service provider-side electronic monitoring apparatus 160 checks the electronic monitoring start history when receiving the first de-registration message and transmits a second de-registration message to the law enforcement agency if the PSS is under the packet service electronic monitoring start process (S426).

As shown in FIG. 2, when a PSS that is under the electronic monitoring start process receives a packet service, the packet service electronic monitoring apparatus transmits a packet of the PSS under the electronic monitoring to the law enforcement agency (S230).

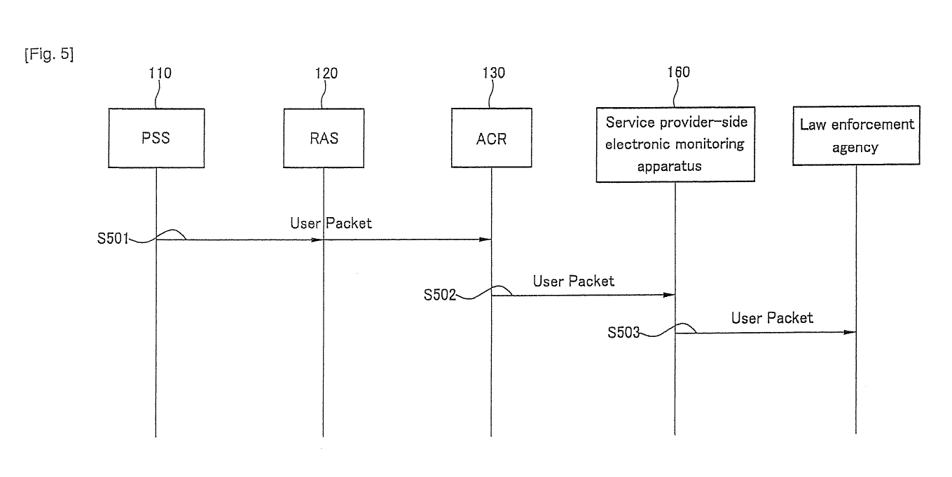

A process for transmitting a packet of a PSS under electronic monitoring will now be described with reference to FIG. 5. FIG. 5 shows a packet transmission process of a PSS under packet service electronic monitoring in the packet service electronic monitoring method according to the exemplary embodiment of the present invention.

As shown in FIG. 5, when a packet transmitted to or received at the PSS 110 is transmitted to the ACR 130 through the RAS 120 after a packet service process is finished (S501), the ACR 130 copies the packet of the PSS 110 and transmits the copy of the packet to the service provider-side electronic monitoring apparatus 160 (S502), and the service provider-side electronic monitoring apparatus 160 checks the electronic monitoring history upon receiving the copied packet and transmits the copied packet to the law enforcement agency if the PSS 110 is under the electronic monitoring start process (S503).

As shown in FIG. 2, the packet service monitoring apparatus cancels the packet service monitoring operation when receiving a packet service electronic monitoring cancellation request from the law enforcement agency (S240).

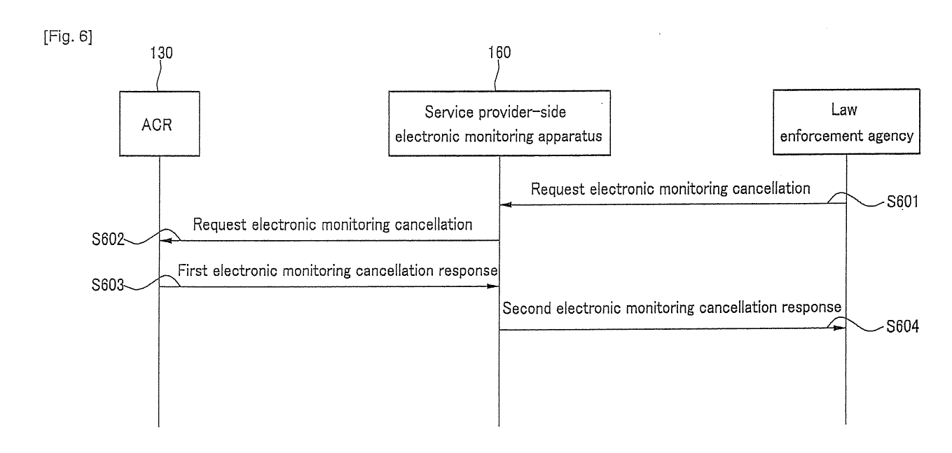

A packet service electronic monitoring cancellation process will be described with reference to FIG. 6. FIG. 6 shows a packet service electronic monitoring cancellation process in the packet service electronic monitoring method according to the exemplary embodiment of the present invention.

When the law enforcement agency requests to cancel packet service electronic monitoring of a PSS 110 (S601), the service provider-side electronic monitoring apparatus 160 checks an electronic monitoring history for the PSS 110 and requests the ACR 130 that manages a call of the PSS 110 to cancel the packet service electronic monitoring if the PSS 110 is under the packet service electronic start process (S602). Then, the ACR 130 cancels the packet service electronic monitoring operation for the PSS 110 and transmits a first electronic monitoring cancellation response to the service provider-side electronic monitoring apparatus 160 (S603). When receiving the first electronic monitoring cancellation response, the service provider-side electronic monitoring apparatus 160 deletes information indicating that the PSS 110 is under the packet service electronic monitoring start process and reports a second electronic monitoring cancellation response to the law enforcement agency (S604).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A packet service electronic monitoring method comprising:
starting packet service electronic monitoring for a portable subscriber station (PSS) upon receiving a packet service electronic monitoring start request from a law enforcement agency;
transmitting electronic monitoring call information of the PSS to the law enforcement agency when the PSS attempts a packet service; and
transmitting a packet of the PSS to the law enforcement agency when the PSS is provided with a packet service.

2. The packet service electronic monitoring method of claim 1, wherein the starting of the packet service electronic monitoring comprises:
receiving a packet service electronic monitoring start request for the PSS from the law enforcement agency;
checking an electronic monitoring start history for the PSS;
requesting a location of the PSS from a home subscriber server/Authentication, Authorization, and Accounting (HSS/AAA) server if the PSS is not under the packet service electronic monitoring;
receiving the location of the PSS from the HSS/AAA;
requesting an access control router (ACR) that manages a call of the PSS to start packet service electronic monitoring; and
receiving an electronic monitoring start response from the ACR.

3. The packet service electronic monitoring method of claim 1, wherein the transmitting of the electronic monitoring call information comprises:
transmitting a registration message of the PSS to the law enforcement agency; and
transmitting a dynamic service addition message of the PSS to the law enforcement agency.

4. The packet service electronic monitoring method of claim 3, wherein the transmitting of the registration message comprises:
receiving a first registration message from an ACR that has exchanged a registration request message and a registration response message with the PSS; and
checking an electronic monitoring start history of the PSS and transmitting a second registration message to the law enforcement agency if the PSS is under the packet service electronic monitoring.

5. The packet service electronic monitoring method of claim 3, wherein the transmitting of the dynamic service addition message comprises:
receiving a first dynamic service addition message from an ACR that has exchanged a dynamic service addition request message, a dynamic service addition response message, and a dynamic service addition acknowledge message with the PSS; and
checking an electronic monitoring start history of the PSS and transmitting a second dynamic service addition message if the PSS is under the packet service electronic monitoring.

6. The packet service electronic monitoring method of claim 3, comprising:
transmitting a dynamic service change message of the PSS to the law enforcement agency; and
transmitting a dynamic service deletion message of the PSS to the law enforcement agency.

7. The packet service electronic monitoring method of claim 6, wherein the transmitting of the dynamic service change message comprises:
receiving a first dynamic service change message from an ACR that has exchanged a dynamic service change request message, a dynamic service change response message, and a dynamic service change acknowledge message with the PSS; and
checking an electronic monitoring start of the PSS and transmitting a second dynamic service change message if the PSS is under the packet service electronic monitoring.

8. The packet service electronic monitoring method of claim 3, comprising:
receiving a first de-registration message from an ACR that has deleted registration of the PSS; and
checking an electronic monitoring start history and transmitting a second de-registration message if the PSS is under the packet service electronic monitoring.

9. The packet service electronic monitoring method of claim 1, wherein the transmitting of the packet of the PSS that is under the electronic monitoring comprises:
receiving a packet from an ACR that has received a packet transmitted from or received by the PSS; and
checking an electronic monitoring start history of the PSS and transmitting the packet of the PSS to the law enforcement agency if the PSS is under the packet service electronic monitoring.

10. The packet service electronic monitoring method of claim 9, further comprising receiving a packet service electronic monitoring cancellation request from the law enforcement agency and canceling the packet service electronic monitoring.

11. The packet service electronic monitoring method of claim 10, wherein the canceling of the packet service electronic monitoring comprises:
receiving a packet service electronic monitoring cancellation request for the PSS from the law enforcement agency;
requesting packet service electronic monitoring cancellation from an ACR that manages a call of the PSS;
receiving a first electronic monitoring cancellation response from the ACR; and
deleting information indicating that the PSS is under the electronic monitoring, and transmitting a second electronic monitoring cancellation response to the law enforcement agency.
